(19) United States
(12) Patent Application Publication
(10) Pub. No.: US 2026/0120590 A1
(43) Pub. Date: Apr. 30, 2026

(54) SYSTEM AND METHOD FOR A DRIVING SCENARIO SIMULATOR

(71) Applicant: TOYOTA RESEARCH INSTITUTE, INC., Los Altos, CA (US)

(72) Inventors: Xiongyi CUI, Somerville, MA (US); Emily S. SUMNER, Cambridge, MA (US); Jonathan A. DECASTRO, Arlington, MA (US); Deepak EDAKKATTIL GOPINATH, Washington, DC (US); Andrew Michael SILVA, Cambridge, MA (US); Thomas M. BALCH, Damariscotta, ME (US); Guy ROSMAN, Newton, MA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/933,913

(22) Filed: Oct. 31, 2024

(51) Int. Cl. G09B 9/05

(52) U.S. Cl. CPC G09B 9/05

(57) ABSTRACT

A method for a vehicle-based driving simulator is described. The method includes reading a current configuration/setting/driving mode of a vehicle. The method also includes generating a dynamic model of the vehicle based on the current configuration/setting/driving mode of the vehicle. The method further includes selecting a virtual driving scenario for the vehicle according to the current configuration/setting/driving mode of the vehicle. The method includes actuating hardware of the vehicle to simulate performance of the selected virtual driving scenario in the vehicle.

### BACKGROUND

### Field

Certain aspects of the present disclosure relate to autonomous vehicle technology and, more particularly, to a system and method for a driving scenario simulator.

### Background

Autonomous agents (e.g., vehicles, robots, etc.) rely on machine vision and sensors (IMU, GPS, etc.) for estimating an agent's state (velocity, position, etc.) for sensing a surrounding environment by analyzing areas of interest in a scene from images of the surrounding environment. Autonomous agents, such as driverless cars and robots, are quickly evolving and have become a reality in this decade. The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle, then the autonomous vehicle with a higher-level number offers a greater combination and quantity of autonomous features relative to the other vehicle.

These various levels of autonomous vehicles may provide a safety system that improves driving of a vehicle by providing an advanced driver assistance system (ADAS), a collision avoidance system, and other like vehicle safety systems. For example, a set of ADAS features may include electric stability control (ESC) systems. Unfortunately, a vehicle user may be unfamiliar with the safety systems specifically installed on the vehicle. A vehicle-based simulator that familiarizes the user with conditions in which the safety systems specifically installed on the vehicle are triggered, potential responses, an amount of time available for the user to react to a situation, is desired.

### SUMMARY

A method for a vehicle-based driving simulator is described. The method includes reading a current configuration/setting/driving mode of a vehicle. The method also includes generating a dynamic model of the vehicle based on the current configuration/setting/driving mode of the vehicle. The method further includes selecting a virtual driving scenario for the vehicle according to the current configuration/setting/driving mode of the vehicle. The method includes actuating hardware of the vehicle to simulate performance of the selected virtual driving scenario in the vehicle.

A non-transitory computer-readable medium having program code recorded thereon for a vehicle-based driving simulator is described. The program code is executed by a processor. The non-transitory computer-readable medium includes program code to read a current configuration/setting/driving mode of a vehicle. The non-transitory computer-readable medium also includes program code to generate a dynamic model of the vehicle based on the current configuration/setting/driving mode of the vehicle. The non-transitory computer-readable medium further includes program code to select a virtual driving scenario for the vehicle according to the current configuration/setting/driving mode of the vehicle. The non-transitory computer-readable medium also includes program code to actuate hardware of the vehicle to simulate performance of the selected virtual driving scenario in the vehicle.

A system for a vehicle-based driving simulator is described. The system includes a vehicle driving mode module to read a current configuration/setting/driving mode of a vehicle. The system also includes a vehicle dynamics model to simulate a dynamic model of the vehicle based on the current configuration/setting/driving mode of the vehicle. The system further includes a virtual driving scenario module to select a virtual driving scenario for the vehicle according to the current configuration/setting/driving mode of the vehicle. The system also includes a vehicle hardware actuation module to actuate hardware of the vehicle to simulate performance of the selected virtual driving scenario in the vehicle.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation using a system-on-a-chip (SOC) for a vehicle-based driving simulator system, in accordance with aspects of the present disclosure.

FIG. 2 is a block diagram illustrating a software architecture that may modularize artificial intelligence (AI) functions for a vehicle-based driving simulator system, according to aspects of the present disclosure.

FIG. 3 is a diagram illustrating an example of a hardware implementation for a vehicle-based driving simulator system, according to aspects of the present disclosure.

FIGS. 4A-4B are block diagrams illustrating a vehicle configured with a vehicle-based simulator system, according to aspects of the present disclosure.

FIG. 5 illustrates a lane keeping assist (LKA) system during simulated operation of a vehicle, according to aspects of the present disclosure.

FIG. 6 is a block diagram illustrating a vehicle-based driving simulator process, according to various aspects of the present disclosure.

FIG. 7 is a flowchart illustrating a method for a vehicle-based, driving simulator, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

The National Highway Traffic Safety Administration (“NHTSA”) has defined different “levels” of autonomous vehicles (e.g., Level 0, Level 1, Level 2, Level 3, Level 4, and Level 5). These various levels of autonomous vehicles may provide a safety system that improves driving of a vehicle. For example, in a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle. The set of ADAS features installed in the autonomous vehicle may be a lane centering assistance system, a lane departure warning system, and/or a brake assistance system and, in some configurations, intervene automatically in a guardian-mode as part of a shared control system.

These various levels of autonomous vehicles may provide a safety system that improves driving of a vehicle by providing the noted ADAS features as well as a collision avoidance system, and other like vehicle safety systems. For example, a set of ADAS features may also include electric stability control (ESC) systems. Unfortunately, a vehicle user may be unfamiliar with the safety systems specifically installed on the vehicle. A vehicle-based simulator that familiarizes the user with conditions in which the safety systems specifically installed on the vehicle are triggered, potential responses, an amount of time available for the user to react to a situation, is desired.

Various aspects of the present disclosure are directed to configuring a vehicle for operation as a driving simulator to provide a vehicle-based driving simulator. According to various aspects of the present disclosure, the vehicle-based driving simulator is configured to generate a virtual scenario in a vehicle using vehicle hardware and current configuration/settings/driving mode of the vehicle. The current configuration/settings/driving mode of the vehicle includes onboard safety systems and hardware in the loop, such as electronic control units (ECUs) in the loop. Once the vehicle scenario is generated, the vehicle-based driving simulator provides feedback to simulate the virtual scenario. For example, possible virtual scenarios supported by the vehicle-based driving simulator include driving on icy road(s), sudden stops on a highway, an animal crossing the road in the dark, etc.

According to various aspects of the present disclosure, the vehicle-based driving simulator is configured to simulate the full dynamics of the vehicle and agents that interact with the vehicle. In some implementations, the vehicle-based driving simulator is implemented in a vehicle that is configured with a steer-by-wire system. In a vehicle implemented with a steer-by-wire system, the steering wheel can move freely when there is no power to the steer-by-wire system (e.g., when the vehicle is in an off-state and parked). In this scenario, the steering wheel is available so that the vehicle can be configured to operate as a vehicle-based driving simulator.

In some implementations, the vehicle-based driving simulator specifies additional hardware. For example, the additional hardware may include a computer node communicably connected (e.g., wired, or wireless) to the vehicle hardware and/or software configured to cause the vehicle to operate as a driving simulator. During operation, the vehicle-based driving simulator is configured to read current configuration/settings/driving mode of the vehicle. In some implementations, the vehicle-based driving simulator generates a dynamic model of the vehicle based on the current configuration/settings/driving mode of the vehicle. Additionally, the vehicle-based driving simulator may utilize a virtual reality headset or a tablet computer as a display.

The vehicle-based driving simulator beneficially allows a user to become familiar with the safety systems of the vehicle as well as explore how the user could respond to an emergency situation. More specifically, the vehicle-based driving simulator can allow the user to evaluate the safety systems specifically installed on the vehicle (as opposed to a general safety system). Testing of the safety systems specifically installed on the vehicle familiarizes the user with conditions in which the safety systems specifically installed on the vehicle are triggered, potential responses, an amount of time available for the user to react to a situation. For example, the safety systems specifically installed on the vehicle may include an advanced driver assistance system (ADAS), a collision avoidance system, and other like vehicle safety systems.

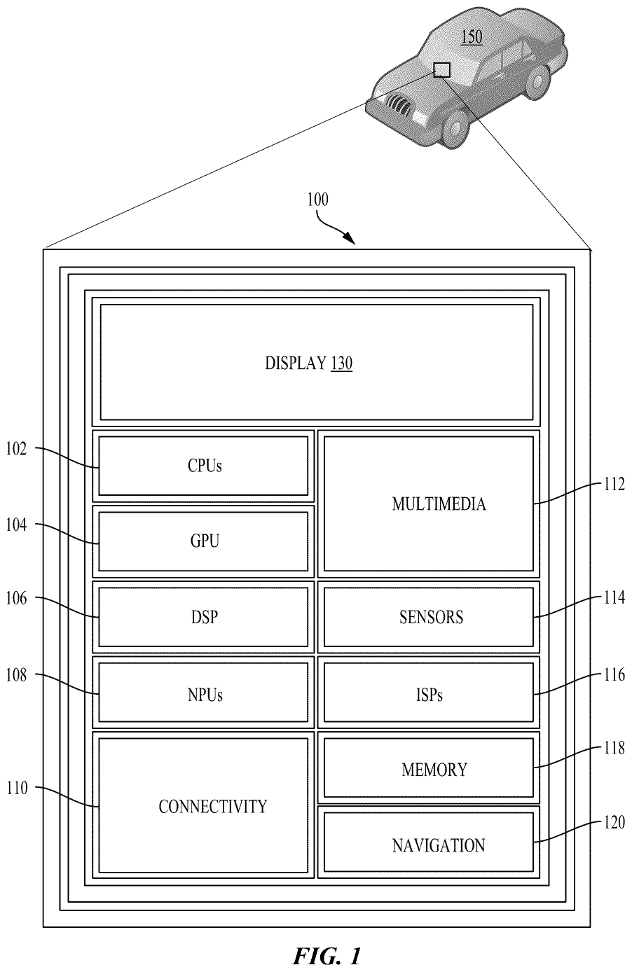

FIG. 1 illustrates an example implementation of the aforementioned system and method for a vehicle-based driving simulator system using a system-on-a-chip (SOC) 100 of a vehicle 150. The SOC 100 may include a single processor or multi-core processors (e.g., a central processing unit (CPU) 102), in accordance with certain aspects of the present disclosure. Variables, system parameters associated with a computational device, delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, unlicensed WiFi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risk Machine (ARM) instruction set or the like. In another aspect of the present disclosure, the SOC 100 may be a server computer in communication with the vehicle 150. In this arrangement, the vehicle 150 may include a processor and other features of the SOC 100. In this aspect of the present disclosure, instructions loaded into a processor (e.g., CPU 102) or the NPU 108 of the vehicle 150 may include program code to perform a vehicle-based driving simulator for familiarizing a user with the vehicle safety system. For example, a vehicle-based driving simulator system generates a virtual scenario in the vehicle using a vehicle hardware and current configuration/settings/driving mode of the vehicle.

The instructions loaded into a processor (e.g., NPU 108) may also include program code to read a current configuration/setting/driving mode of a vehicle. The instructions loaded into a processor (e.g., NPU 108) may also include program code to generate a dynamic model of the vehicle based on the current configuration/settings/driving mode of the vehicle. The instructions loaded into a processor (e.g., NPU 108) may also include program code to select a virtual driving scenario for the vehicle according to the current configuration/settings/driving mode of the vehicle. The instructions loaded into a processor (e.g., NPU 108) may also include program code to actuate hardware of the vehicle to simulate performance of the selected virtual driving scenario in the vehicle.

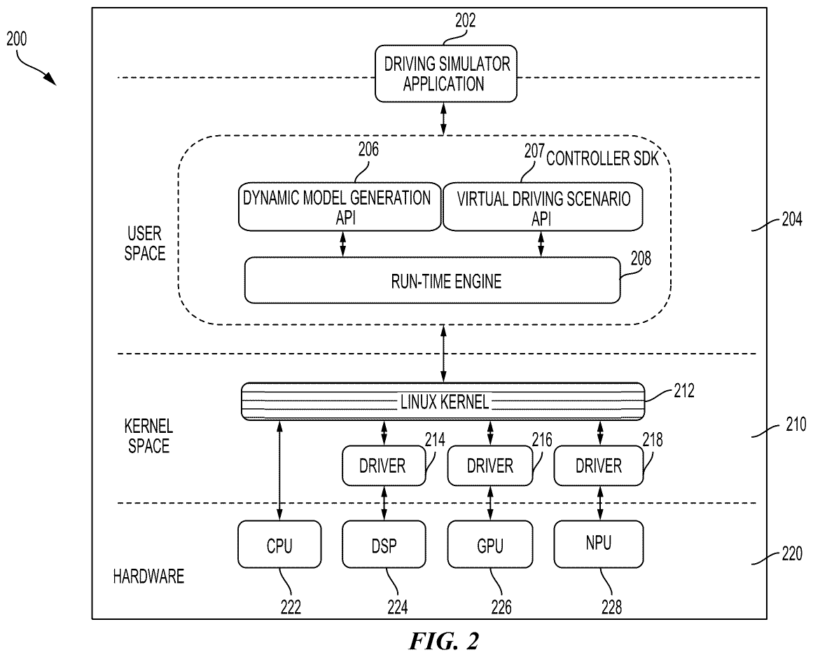

FIG. 2 is a block diagram illustrating a software architecture 200 that may modularize artificial intelligence (AI) functions for a vehicle-based driving simulator system, according to aspects of the present disclosure. Using the software architecture 200, a driving simulator application 202 may be designed such that it may cause various processing blocks of a system-on-a-chip (SOC) 220 (e.g., a CPU 222, a DSP 224, a GPU 226, and/or an NPU 228) to perform supporting computations during run-time operation of the driving simulator application 202. While FIG. 2 describes the software architecture 200 for vehicle-based driving simulator features, it should be recognized that the vehicle-based driving simulator features are not limited to autonomous agents. According to aspects of the present disclosure, the vehicle-based driving simulator system is applicable to any vehicle type, provided the vehicle is equipped with appropriate functions of an advanced driver assistance system (ADAS).

The driving simulator application 202 may be configured to call functions defined in a user space 204 that may, for example, provide for vehicle-based driving simulation for providing driving skill improvement services. The driving simulator application 202 may make a request to compile program code associated with a library defined in a dynamic model generation application programming interface (API) 206 to a dynamic model of a vehicle based on a current configuration/setting/driving mode read from a vehicle. The driving simulator application 202 may also make a request to compile program code associated with a library defined in a virtual driving scenario API 207 to select a virtual driving scenario for the vehicle according to the current configuration/settings/driving mode of the vehicle. In response, hardware of the vehicle is actuated to simulate performance of the selected virtual driving scenario in the vehicle.

A run-time engine 208, which may be compiled code of a runtime framework, may be further accessible to the driving simulator application 202. The driving simulator application 202 may cause the run-time engine 208, for example, to take actions for communicating with a vehicle operator. When the vehicle operator begins to interact with a vehicle interface, the run-time engine 208 may in turn send a signal to an operating system 210, such as a Linux Kernel 212, running on the SOC 220. FIG. 2 illustrates the Linux Kernel 212 as software architecture for simulating safety features of the vehicle. It should be recognized, however, that aspects of the present disclosure are not limited to this exemplary software architecture. For example, other kernels may be used to provide the software architecture to support the vehicle-based driving simulator control functionality to allow the user to evaluate the safety systems specifically installed on the vehicle (as opposed to a general safety system).

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, a dynamic model may be configured to run on a combination of processing blocks, such as the CPU 222 and the GPU 226, or may be run on the NPU 228 if present.

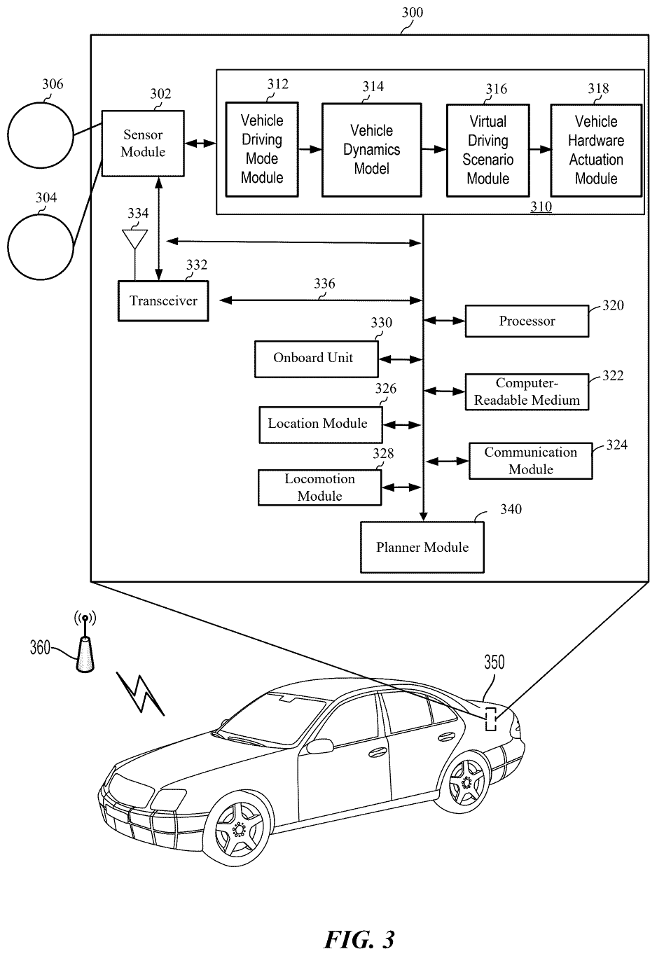

FIG. 3 is a diagram illustrating an example of a hardware implementation for a vehicle-based driving simulator system 300, according to aspects of the present disclosure. The vehicle-based driving simulator system 300 may be configured to familiarize a user with conditions in which the safety systems specifically installed on a vehicle 350 are triggered, potential responses, an amount of time available for the driver to react to the situation of the vehicle 350. The vehicle-based driving simulator system 300 may be a component of a vehicle or other non-autonomous device (e.g., non-autonomous vehicles). For example, as shown in FIG. 3, the vehicle-based driving simulator system 300 is a component of the vehicle 350.

Aspects of the present disclosure are not limited to the vehicle-based driving simulator system 300 being a component of the vehicle 350. Other devices, such as a bus, motorcycle, or other like non-autonomous vehicle, are also contemplated for implementing the vehicle-based driving simulator system 300. In this example, the vehicle 350 may be autonomous or semi-autonomous; however, other configurations for the vehicle 350 are contemplated, such as an advanced driver assistance system (ADAS).

The vehicle-based driving simulator system 300 may be implemented with an interconnected architecture, such as a controller area network (CAN) bus, represented by an interconnect 308. The interconnect 336 may include any number of point-to-point interconnects, buses, and/or bridges depending on the specific application of the vehicle-based driving simulator system 300 and the overall design constraints. The interconnect 336 links together various circuits including one or more processors and/or hardware modules, represented by a sensor module 302, a vehicle safety controller 310, a processor 320, a computer-readable medium 322, a communication module 324, a location module 326, a locomotion module 328, an onboard unit 330, and a planner module 340. The interconnect 336 may also link various other circuits such as timing sources, peripherals, voltage regulators, and power management circuits, which are well known in the art, and therefore, will not be described further.

The vehicle-based driving simulator system 300 includes a transceiver 332 coupled to the sensor module 302, the vehicle safety controller 310, the processor 320, the computer-readable medium 322, the communication module 324, the location module 326, the locomotion module 328, the onboard unit 330, and the planner module 340. The transceiver 332 is coupled to antenna 334. The transceiver 332 communicates with various other devices over a transmission medium. For example, the transceiver 332 may receive commands via transmissions from a user or a connected vehicle. In this example, the transceiver 332 may receive/transmit vehicle-to-vehicle traffic state information for the vehicle safety controller 310 to/from connected vehicles within the vicinity of the vehicle 350.

The vehicle-based driving simulator system 300 includes the processor 320 coupled to the computer-readable medium 322. The processor 320 performs processing, including the execution of software stored on the computer-readable medium 322 to provide functionality according to the disclosure. The software, when executed by the processor 320, causes the vehicle-based driving simulator system 300 to predict the vehicle 350 entering an unsafe operating range if a vehicle command requested by a vehicle operator of the vehicle 350 is performed. The vehicle-based driving simulator system 300 is further caused to adjust the vehicle command to maintain control of the vehicle 350 in the unsafe operating range. The computer-readable medium 322 may also be used for storing data that is manipulated by the processor 320 when executing the software.

The sensor module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images of the vehicle operator. The second sensor 304 may be a ranging sensor, such as a light detection and ranging (LIDAR) sensor or a radio detection and ranging (RADAR) sensor for capturing an external vehicle environment. Of course, aspects of the present disclosure are not limited to the aforementioned sensors as other types of sensors (e.g., thermal, sonar, and/or lasers) are also contemplated for either of the first sensor 306 or the second sensor 304.

The measurements of the first sensor 306 and the second sensor 304 may be processed by the processor 320, the sensor module 302, the vehicle safety controller 310, the communication module 324, the location module 326, the locomotion module 328, the onboard unit 330, and/or the planner module 340. In conjunction with the computer-readable medium 322, the measurements of the first sensor 306 and the second sensor 304 are processed to implement the functionality described herein. In one configuration, the data captured by the first sensor 306 and the second sensor 304 may be transmitted to a connected vehicle via the transceiver 332. The first sensor 306 and the second sensor 304 may be coupled to the vehicle 350 or may be in communication with the vehicle 350.

The location module 326 may determine a location of the vehicle 350. For example, the location module 326 may use a global positioning system (GPS) to determine the location of the vehicle 350. The location module 326 may implement a dedicated short-range communication (DSRC)-compliant GPS unit. A DSRC-compliant GPS unit includes hardware and software to make the vehicle 350 and/or the location module 326 compliant with one or more of the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 332. For example, the communication module 324 may be configured to provide communication capabilities via different wireless protocols, such as 6G, 5G NR, WiFi, long term evolution (LTE), 4G, 3G, etc. The communication module 324 may also communicate with other components of the vehicle 350 that are not modules of the vehicle-based driving simulator system 300. The transceiver 332 may be a communications channel through a network access point 360. The communications channel may include DSRC, 6G, 5G NR, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G NR, 6G, LTE, LTE-V2X, LTE-D2D, VoLTE, or any other mobile data network or combination of mobile data networks. Further, the network access point 360 may include one or more IEEE 802.11 wireless networks.

The vehicle-based driving simulator system 300 also includes the planner module 340 for planning a route and controlling the locomotion of the vehicle 350, via the locomotion module 328 for autonomous operation of the vehicle 350. In one configuration, the planner module 340 may override a user input when the user input is expected (e.g., predicted) to cause a collision according to an autonomous level of the vehicle 350. The modules may be software modules running in the processor 320, resident/stored in the computer-readable medium 322, and/or hardware modules coupled to the processor 320, or some combination thereof.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. These distinct levels of autonomous vehicles are described briefly below.

Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks but is still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the district where the vehicle is located).

A highly autonomous vehicle (“HAV”) is an autonomous vehicle that is Level 3 or higher. Accordingly, in some configurations the vehicle 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The vehicle safety controller 310 may be in communication with the sensor module 302, the processor 320, the computer-readable medium 322, the communication module 324, the location module 326, the locomotion module 328, the onboard unit 330, the transceiver 332, and the planner module 340. In one configuration, the vehicle safety controller 310 receives sensor data from the sensor module 302. The sensor module 302 may receive the sensor data from the first sensor 306 and the second sensor 304. According to aspects of the present disclosure, the sensor module 302 may filter the data to remove noise, encode the data, decode the data, merge the data, extract frames, or perform other functions. In an alternate configuration, the vehicle safety controller 310 may receive sensor data directly from the first sensor 306 and the second sensor 304 to determine, for example, input traffic data images.

The various levels of autonomous vehicles may provide a safety system that improves driving of a vehicle by providing the noted ADAS features as well as a collision avoidance system, and other like vehicle safety systems. For example, a set of ADAS features may also include electric stability control (ESC) systems. Unfortunately, a vehicle user may be unfamiliar with the safety systems specifically installed on the vehicle. A vehicle-based simulator that familiarizes the user with conditions in which the safety systems specifically installed on the vehicle are triggered, potential responses, an amount of time available for the user to react to a situation, is desired.

Various aspects of the present disclosure are directed to configuring the vehicle 350 for operation as a driving simulator to provide a vehicle-based driving simulator. According to various aspects of the present disclosure, the vehicle-based driving simulator system 300 is configured to generate a virtual scenario in a vehicle using vehicle hardware and current configuration/settings/driving mode of the vehicle. For example, possible virtual scenarios supported by the vehicle-based driving simulator system 300 include driving on icy road(s), sudden stops on a highway, an animal crossing the road in the dark, etc.

According to various aspects of the present disclosure, the vehicle-based driving simulator system 300 is configured to simulate the full dynamics of the vehicle and agents that interact with the vehicle 350. In some implementations, the vehicle is configured with a steer-by-wire system, in which the steering wheel can move freely when there is no power to the steer-by-wire system (e.g., when the vehicle is in an off-state and parked). In this scenario, the steering wheel is available so that the vehicle 350 can be configured according to the vehicle-based driving simulator system 300.

As shown in FIG. 3, the vehicle-based driving simulator system 300 includes the vehicle safety controller 310 that includes a vehicle driving mode module 312, a vehicle dynamics model 314, a virtual driving scenario module 316, and a vehicle hardware actuation module 318. The vehicle dynamics model 314, the virtual driving scenario module 316, and/or the vehicle hardware actuation module 318 may be implemented using a convolutional neural network (CNN). The vehicle safety controller 310 is not limited to a CNN.

The vehicle driving mode module 312 is configured to read a current configuration/setting/driving mode of the vehicle 350. The vehicle dynamics model 314 is configured to generate a dynamic model of the vehicle 350 based on the current configuration/settings/driving mode of the vehicle. The virtual driving scenario module 316 is configured to select a virtual driving scenario for the vehicle 350 according to the current configuration/settings/driving mode of the vehicle 350. The vehicle hardware actuation module 318 is configured to actuate hardware of the vehicle 350 to simulate performance of the selected virtual driving scenario in the vehicle.

As described in further detail below, a vehicle user may be unfamiliar with the safety systems specifically installed on the vehicle 350. The vehicle-based driving simulator system 300 familiarizes the driver with conditions in which the safety systems specifically installed on the vehicle 350 are triggered, potential responses, an amount of time available for the user to react to a situation. Various aspects of the present disclosure may be implemented in an agent, such as the vehicle 350. The vehicle 350 may operate in either an autonomous mode, a semi-autonomous mode, or a manual mode. In some examples, the vehicle 350 may switch between operating modes.

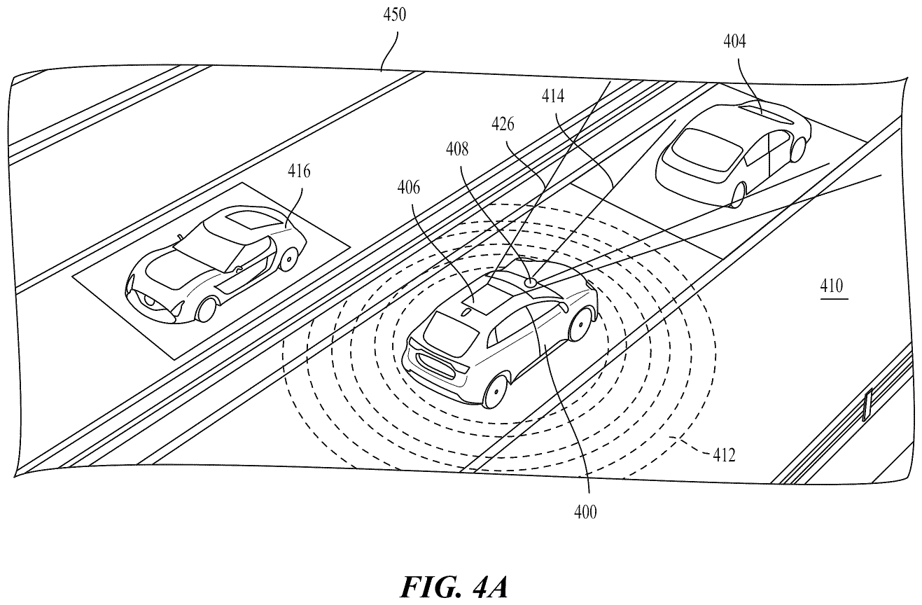

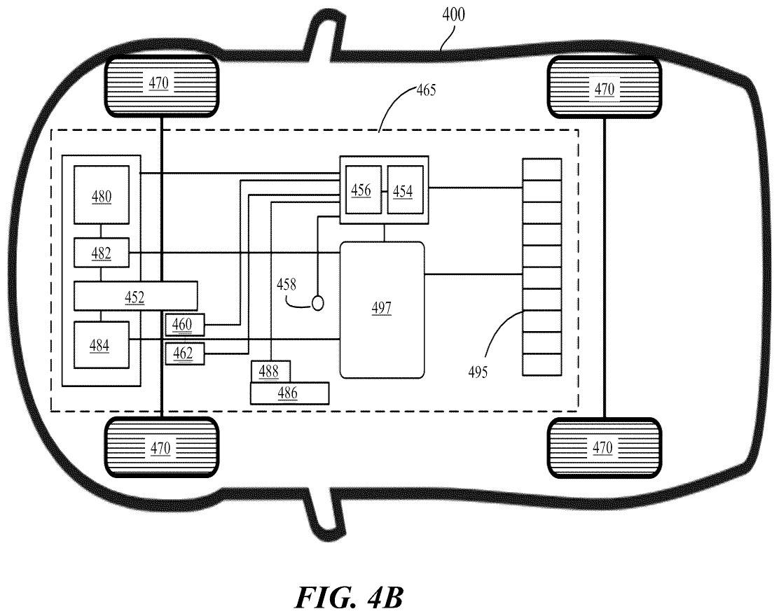

FIGS. 4A-4B are block diagrams illustrating a vehicle configured with a vehicle-based simulator system, according to aspects of the present disclosure.

FIG. 4A is a diagram illustrating an example of a vehicle 400 in an environment 450, in accordance with various aspects of the present disclosure. In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system (e.g., the sensor module 302). Other sensors, such as radar and/or ultrasound, are also contemplated. Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera's 408 field of view 414. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward-facing field of view, such as the 2D camera's 408 field of view 414 and/or the 2D sensor's 406 field of view 426.

The 2D image captured by the 2D camera 408 includes a 2D image of the first vehicle 404, as the first vehicle 404 is in the 2D camera's 408 field of view 414. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream 424.

The information obtained from the LIDAR sensor 406 and the 2D camera 408 may be used to evaluate a driving environment. In some examples, the information obtained from the LIDAR sensor 406 and the 2D camera 408 may identify whether the vehicle 400 is at an intersection or a crosswalk. Additionally, or alternatively, the information obtained from the LIDAR sensor 406 and the 2D camera 408 may identify whether one or more dynamic objects, such as pedestrians, are near the vehicle 400.

FIG. 4B is a diagram illustrating an example of a vehicle 400, in accordance with various aspects of the present disclosure. It should be understood that various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and an accelerometer 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. The MGs 482 and 484 can also output torque to the transmission 452. The engine 480 and the MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The accelerometer 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, the engine 480 should provide a fraction of the applied torque to the wheels 470 while one or both of the MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle 400. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456, so as to convert direct current (DC) power from the battery 495 to alternating current (AC) power and supply the AC power to the MGs 482 and 484. In some examples, a first MG 482 may be driven by electric power generated by a second MG 484. It should be understood that in embodiments where MGs 482 and 484 are DC motors, no inverter is required. The inverter 497, in conjunction with a converter assembly, may also accept power from one or more of the MGs 482 and 484 (e.g., during engine charging), convert this power from AC back to DC, and use this power to charge the battery 495 (hence the name, motor generator). The ECU 456 may control the inverter 497, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting, during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current as a result of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both of the MGs 482 and 484. When the battery 495 is implemented using one or more batteries, the batteries can include, for example, nickel metal hydride batteries, lithium-ion batteries, lead acid batteries, nickel cadmium batteries, lithium-ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

Testing of safety systems specifically installed on the vehicle 400 familiarizes the user with conditions in which the safety systems specifically installed on the vehicle 400 are triggered, potential responses, an amount of time available for the user to react to a situation. For example, the safety systems specifically installed on the vehicle 400 may include an advanced driver assistance system (ADAS), a collision avoidance system, and other like vehicle safety systems.

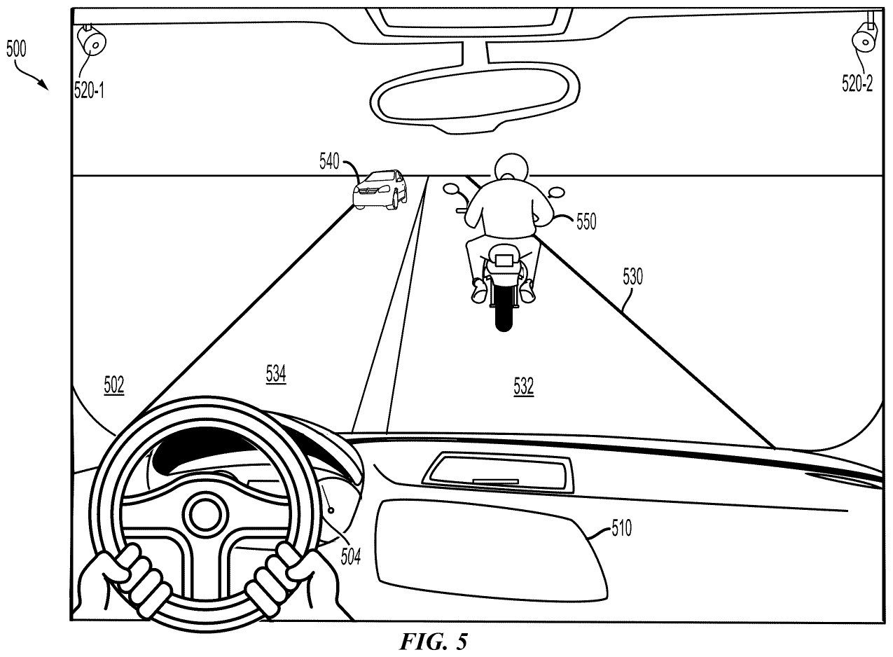

In various aspects of the present disclosure, implementation of the vehicle-based driving simulator system 300 of FIG. 3 in the vehicle 400 familiarizes the user with conditions in which the safety systems specifically installed on the vehicle 400 are triggered, potential responses, an amount of time available for the user to react to a situation. This familiarization with the safety systems specifically installed on the vehicle 400 improves vehicle safety in emergency conditions, such as tire saturation from encountering low friction or from emergency lane changes. For example, the safety systems specifically installed on the vehicle 400 may include an advanced driver assistance system (ADAS), a collision avoidance system, and other like vehicle safety systems, for example, as shown in FIG. 5.

FIG. 5 illustrates a lane keeping assist (LKA) system during simulated operation of a vehicle, according to aspects of the present disclosure. The LKA is an advanced driver assistance system (ADAS) feature that monitors the position of the vehicle with respect to roadway and highway lane boundaries. In response to monitoring the vehicle with respect to the lane boundaries, the LKA system applies torque to a vehicle steering wheel and/or pressure to the vehicle brakes when a lane departure is about to occur. In some implementations, the LKA system provides an audible alert and a slight nudge to the steering wheel for alerting a driver to take appropriate corrective action.

FIG. 5 illustrates a cabin of an ego vehicle 500, including a front-windshield 502, a steering wheel 504, cameras 520 (520-1, 520-2), and a heads-up display (HUD) 510, which enables the operator of the vehicle to monitor operation of the ego vehicle 500 and receive alerts. Video plays a key role in training, skill-improvement, and skill preparation. As shown in FIG. 5, a projection system is utilized for visual simulation of a vehicle-based driving simulator using the front-windshield 502 and steering wheel 504 of the ego vehicle 500. In some implementations, the cameras 520 are utilized to acquire a driver's head pose to update the visual simulation from the vehicle-based driving simulator of the ego vehicle 500.

In this simulation, the ego vehicle 500 is in a first lane 532 of a roadway 530, including a cycle 550 in the first lane 532 and an oncoming vehicle 540 in a second lane 534 of the roadway 530. As described, the cycle 550 and the oncoming vehicle 540 may be referred to as external road agents. In this simulation, the LKA system of the ego vehicle 500 detects a lane violation, as the ego vehicle 500 is straddling a centerline and has crossed over from the first lane 532 to the second lane 534 of the roadway 530.

In this simulation, the LKA system determines the general location of the ego vehicle 500 within the first lane 532 of the roadway 530. As the ego vehicle 500 slowly moves from the center of the first lane 532 and towards the second lane 534 and there is no indication that this movement is intended (e.g., turn signal has not been actuated, route guidance does not indicate that a lane change should be made, etc.) the LKA system simulation may apply a mild amount of torque to the steering wheel 504 to reposition the ego vehicle 500 within the first lane 532. Additionally, simulating vehicle acceleration and/or deceleration may be performed using an air suspension of the ego vehicle 500.

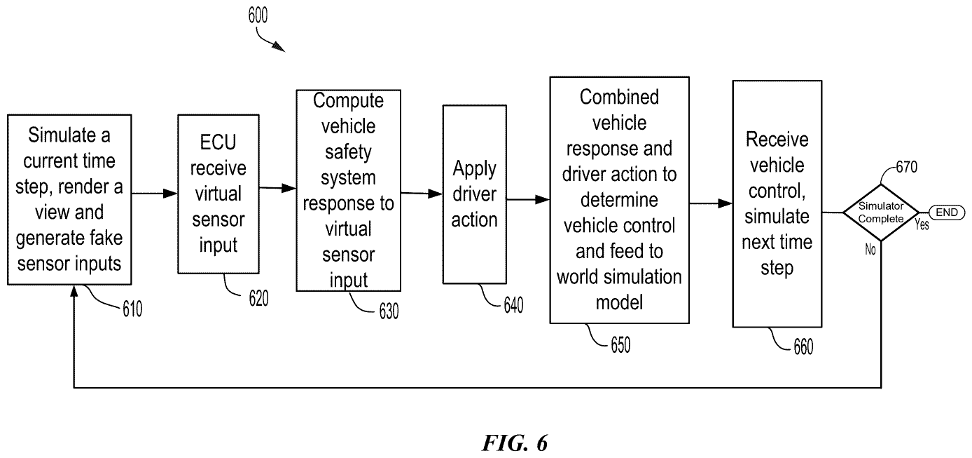

According to various aspects of the present disclosure, a vehicle-based driving simulator system provides hardware-in-the-loop simulation for testing vehicle safety systems. As shown in FIG. 5, the driver experiences a vehicle safety system by utilizing the vehicle radar and vision sensors for generating virtual sensor inputs (e.g., fake sensor inputs). Additionally, hardware-in-the-loop simulation is utilized for enabling a production vehicle to evaluate safety system reactions. As shown in FIG. 5, specific vehicle hardware and a projection system are utilized for visual simulation of the vehicle-based driving simulator. A vehicle-based driving simulator process is illustrated, for example, in FIG. 6.

FIG. 6 is a block diagram illustrating a vehicle-based driving simulator process 600, according to various aspects of the present disclosure. As shown in FIG. 6, at block 610, simulation software world model simulates a current time step, renders a view, and generates fake sensor inputs. In some implementations, a physical switch is provided to engage the vehicle-based driving simulator. According to various aspects of the present disclosure, the vehicle-based driving simulator system provides hardware-in-the-loop simulation for testing vehicle safety systems. In some implementations, a driver experiences a vehicle safety system by utilizing the vehicle radar and vision sensors for generating fake sensor inputs.

At block 620, virtual sensor inputs are generated to simulate radar and vision sensors of the vehicle using a world simulation model. This process further includes feeding the virtual sensor inputs to electric control units (ECU) of the vehicle. In this process, the virtual sensor inputs (e.g., fake sensor outputs) are received by ECUs of a vehicle safety system, which are wired to receive the virtual sensor inputs. Additionally, an air suspension of the vehicle may be tied to the virtual sensor inputs, for example, to tilt or provide the vehicle with a sense of movement. For example, actuating of vehicle hardware includes simulating vehicle acceleration and/or deceleration using an air suspension of the vehicle.

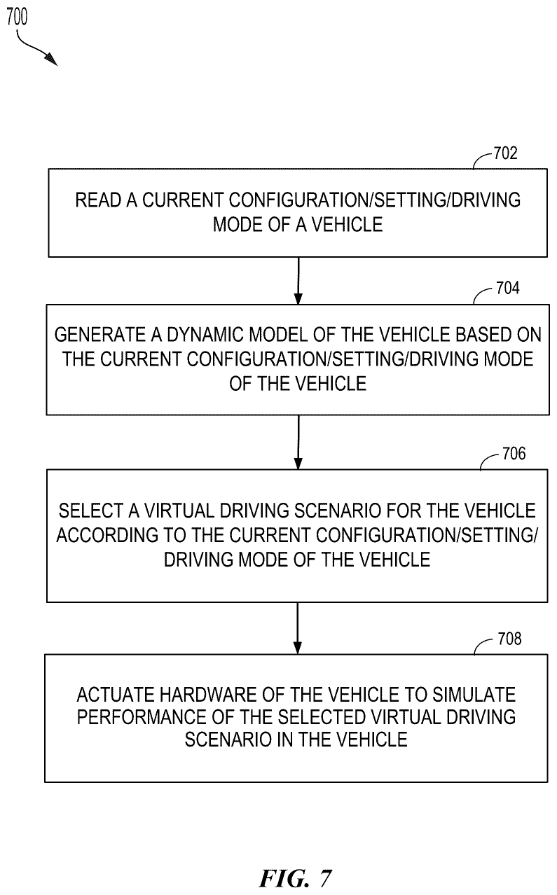

At block 630, a vehicle safety system response to the fake sensor input is computed. Additionally, at block 640, a drive action is applied (e.g., braking, steering, etc.). At block 650, the vehicle response and the driver action are combined to determine a vehicle control action that is fed to a world simulation model. At block 660, the vehicle control action is received, and a next time step is simulated. Blocks 610-660 are repeated until the simulator is completed at block 670. According to various aspects of the present disclosure, the vehicle-based driving simulator process 600 utilizes hardware-in-the-loop simulation, which may enable a production vehicle to evaluate safety system reactions. In some implementations, specific vehicle hardware and a projection system are utilized for visual simulation of the vehicle-based driving simulator, for example, as shown in FIG. 5. A method for a vehicle-based driving simulator is shown, for example, in FIG. 7.

FIG. 7 is a flowchart illustrating a method 700 for a vehicle-based driving simulator, according to aspects of the present disclosure. The method 700 beings at block 702, in which a current configuration/setting/driving mode of a vehicle is read. For example, as shown in FIG. 3, the vehicle driving mode module 312 is configured to read a current configuration/setting/driving mode of the vehicle 350.

At block 704, a dynamic model of the vehicle is generated based on the current configuration/setting/driving mode of the vehicle. For example, as shown in FIG. 3, the vehicle dynamics model 314 is configured to generate a dynamic model of the vehicle 350 based on the current configuration/settings/driving mode of the vehicle.

At block 706, select a virtual driving scenario for the vehicle according to the current configuration/setting/driving mode of the vehicle. For example, as shown in FIG. 3, the virtual driving scenario module 316 is configured to select a virtual driving scenario for the vehicle 350 according to the current configuration/settings/driving mode of the vehicle 350.

At block 708, hardware of the vehicle is actuated to simulate performance of the selected virtual driving scenario in the vehicle. For example, as shown in FIG. 3, the vehicle hardware actuation module 318 is configured to actuate hardware of the vehicle 350 to simulate performance of the selected virtual driving scenario in the vehicle.

In some aspects of the present disclosure, the method shown in FIG. 7 may be performed by the SOC 100 (FIG. 1) or the software architecture 200 (FIG. 2) of the vehicle 150. That is, each of the elements or methods may, for example, but without limitation, be performed by the SOC 100, the software architecture 200, the processor (e.g., CPU 102), and/or other components included therein of the vehicle 150, or the vehicle-based driving simulator system 300.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and nonlinear model predictive control described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for a vehicle-based driving simulator, the method comprising:
reading a current configuration/setting/driving mode of a vehicle;
generating a dynamic model of the vehicle based on the current configuration/setting/driving mode of the vehicle;
selecting a virtual driving scenario for the vehicle according to the current configuration/setting/driving mode of the vehicle; and
actuating hardware of the vehicle to simulate performance of the selected virtual driving scenario in the vehicle.

2. The method of claim 1, further comprising using a virtual reality headset and/or a tablet computer as a display of the vehicle-based driving simulator.

3. The method of claim 1, in which actuating further comprises displaying the virtual driving scenario on a front-windshield of the vehicle.

4. The method of claim 3, further comprising:
determining a head pose of a driver of the vehicle; and
adjusting the displaying of the virtual driving scenario according to the head pose of the driver.

5. The method of claim 1, in which actuating further comprises:
generating virtual sensor inputs to simulate radar and vision sensors of the vehicle using a world simulation model; and
feeding the virtual sensor inputs to electric control units (ECU) of the vehicle.

6. The method of claim 1, in which selecting the virtual driving scenario comprises simulating driving on an icy road, suddenly stopping on a highway, and/or driving through an animal crossing of a road in darkness.

7. The method of claim 1, in which actuating comprises providing haptic feedback to a driver of the vehicle during the virtual driving scenario.

8. The method of claim 7, in which actuating further comprises simulating vehicle acceleration and/or deceleration using an air suspension of the vehicle.

9. A non-transitory computer-readable medium having program code recorded thereon for a vehicle-based driving simulator, the program code being executed by a processor and comprising:
program code to read a current configuration/setting/driving mode of a vehicle;
program code to generate a dynamic model of the vehicle based on the current configuration/setting/driving mode of the vehicle;
program code to select a virtual driving scenario for the vehicle according to the current configuration/setting/driving mode of the vehicle; and
program code to actuate hardware of the vehicle to simulate performance of the selected virtual driving scenario in the vehicle.

10. The non-transitory computer-readable medium of claim 9, further comprising program code to use a virtual reality headset and/or a tablet computer as a display of the vehicle-based driving simulator.

11. The non-transitory computer-readable medium of claim 9, in which the program code to actuate further comprises program code to display the virtual driving scenario on a front-windshield of the vehicle.

12. The non-transitory computer-readable medium of claim 11, further comprising:
program code to determine a head pose of a driver of the vehicle; and
program code to adjust the displaying of the virtual driving scenario according to the head pose of the driver.

13. The non-transitory computer-readable medium of claim 9, in which the program code to actuate further comprises:
program code to generate virtual sensor inputs to simulate radar and vision sensors of the vehicle using a world simulation model; and
program code to feed the virtual sensor inputs to electric control units (ECU) of the vehicle.

14. The non-transitory computer-readable medium of claim 9, in which the program code to select the virtual driving scenario comprises program code to simulate driving on an icy road, suddenly stopping on a highway, and/or driving through an animal crossing of a road in darkness.

15. The non-transitory computer-readable medium of claim 9, in which the program code to actuate further comprises program code to provide haptic feedback to a driver of the vehicle during the virtual driving scenario.

16. The non-transitory computer-readable medium of claim 15, in which the program code to actuate further comprises program code to simulate vehicle acceleration and/or deceleration using an air suspension of the vehicle.

17. A system for a vehicle-based driving simulator, the system comprising:
a vehicle driving mode module to read a current configuration/setting/driving mode of a vehicle;
a vehicle dynamics model to simulate a dynamic model of the vehicle based on the current configuration/setting/driving mode of the vehicle;
a virtual driving scenario module to select a virtual driving scenario for the vehicle according to the current configuration/setting/driving mode of the vehicle; and
a vehicle hardware actuation module to actuate hardware of the vehicle to simulate performance of the selected virtual driving scenario in the vehicle.

18. The system of claim 17, further a virtual reality headset and/or a tablet computer configured to display the vehicle-based driving simulator.

19. The system of claim 17, in which a front-windshield of the vehicle is configured to display the virtual driving scenario.

20. The system of claim 19, in which the front-windshield is configured to adjust the display of the virtual driving scenario according to a head pose of a driver.
